(19) United States
(12) Patent Application Publication
(10) Pub. No.: US 2005/0238268 A1
(43) Pub. Date: Oct. 27, 2005

(54) Motor having a high carbon shaft and powder metal bearing and method of using and manufacturing thereof

(76) Inventors: Gary W. Borcherding, Florissant, MO (US); Barry M. Newberg, Florissant, MO (US); L. Ranney Dohogne, Creve Coeur, MO (US)

Correspondence Address: HARNESS, DICKEY, & PIERCE, P.L.C, 7700 BONHOMME, STE 400, ST. LOUIS, MO, 63105, US

(21) Appl. No.: 10/832,706

(22) Filed: Apr. 27, 2004

(51) Int. Cl. F16C 19/10; F16C 33/02; H02K 5/16

(52) U.S. Cl. 384/279

(57) ABSTRACT

A motor and method of manufacturing a motor having a steel shaft with a carbon content greater than or equal to about 0.4 percent by weight and a powder metal bearing coupled about the shaft. The invention also includes a method of using a motor having a non-hardened steel shaft with a carbon content greater than or equal to about 0.4 percent by weight and a powder metal bearing coupled about the non-secondary hardened shaft. The method includes applying a radial load to the bearing greater than about 25,000 pound-feet per square-inch minute.

### FIELD OF THE INVENTION

The present invention relates to electric motors and methods of using and manufacturing electric motors.

### BACKGROUND OF THE INVENTION

A motor generally includes a shaft and a bearing with the bearing providing for rotary movement of the shaft within the motor. One type of bearing used in motors is a powder metal bearing. Powder metal bearings contain a porous structure that may be filled with a lubricant that conducts through the porous metal structure of the bearing to provide lubrication to the bearing and shaft. However, in some load carrying applications involving large radial loads, powder metal bearings have caused a motor failure. As such, when the load carrying capacity of the bearing is large, a bearing other than a powder metal bearing is often used.

In other motors, a lubricant wick is provided in conjunction with a powder metal bearing to increase the lubrication between the bearing and the shaft to increase the load carrying capacity of the powder metal bearing. The wick is positioned adjacent to the powder metal bearing to provide for the application of supplemental lubricant to the bearing. However, the design and implementation of a wick-fed supplemental lubrication system adds cost and complexity to the motor and its assembly. Furthermore, wick-fed supplemental lubrication of the bearing only provides for a modest increase in the load carrying capacity of the bearing.

In other cases, all or a portion of the shaft is secondary hardened to increase the hardness of the shaft at least in the area where the bearing contacts the shaft, e.g., the bearing journal of the shaft. This is often required since motors have shafts made from low carbon steel such as American Iron and Steel Institute (AISI) rated 1215 steel. Low carbon steel is easily machined that enables the formation of various motor features on the shaft. However, low carbon steel does not often provide the required hardness to support large load carrying capacities. The shaft may be slightly hardened through work hardening which results from grinding or machining the shaft. However, work hardening often does not provide sufficient hardening for large load carrying capacities. As such, the low carbon steel shaft must be further hardened. Such further hardening is referred to as secondary hardening. Secondary hardening of low carbon steel typically involves an extensive thermo-chemical hardening process such as nitriding, carburizing, or carbonitriding. While secondary hardening of the shaft improves the load carrying capacity of the bearing, secondary hardening is both time-consuming and expensive.

Therefore, the inventors have recognized that it would be desirable to develop a motor that uses a non-secondary hardened shaft and a powder metal bearing that is capable of a load carrying capacity (referred to in the industry as a Pressure Velocity or PV rating) on the powder metal bearing greater than about 25,000 pound-feet per square-inch minute.

### SUMMARY

A motor according to one aspect of the invention includes a steel shaft having a carbon content greater than or equal to about 0.4 percent by weight. The shaft is not secondary hardened. A non-wick fed powder metal bearing is coupled about the non-secondary hardened shaft.

In another aspect, the invention includes a method of using a motor having a non-hardened steel shaft with a carbon content greater than or equal to about 0.4 percent by weight and a powder metal bearing coupled about the non-secondary hardened shaft. The method includes applying a radial load to the bearing greater than about 25,000 pound-feet per square-inch minute.

In yet another aspect, the invention includes a method of manufacturing a motor that includes forming a shaft from non-secondary hardened steel having a carbon content greater than or equal to about 0.4 percent by weight. The method also includes coupling a non-wick fed powder metal bearing about the non-secondary hardened shaft.

In still another aspect, the invention includes a shaft and bearing assembly for an electric motor. The shaft and bearing assembly includes a non-secondary hardened shaft having a carbon content greater than or equal to about 0.4 percent. The assembly also includes a non-wick fed powder metal bearing coupled about said shaft.

Further aspects and features of the invention will be in part apparent and in part pointed out in the detailed description provided hereinafter. It should be understood that the detailed description and specific examples, while indicating various embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings.

FIG. 1 is a partial cross-sectional view of a motor having a shaft and bearing according to one embodiment of the invention.

FIG. 2 is a flow chart illustrating a method of manufacturing a motor according to one embodiment of the invention.

Corresponding reference characters indicate corresponding parts throughout the several views of the drawings.

### DETAILED DESCRIPTION OF EXEMPLARY EMBODIMENTS

The following description is merely exemplary in nature and is in no way intended to limit the invention, its application, or uses.

In one embodiment, a motor has a non-secondary hardened steel shaft with a carbon content greater than or equal to about 0.4 percent by weight. The steel shaft may have been work hardened during the forming of the shaft. A non-wick fed powder metal bearing is coupled about the non-secondary hardened shaft. In some applications and embodiments, such a motor may provide for reduced assembly costs while providing a sufficiently hard shaft for coupling with a powder metal bearing to provide for improved load-carrying capacity.

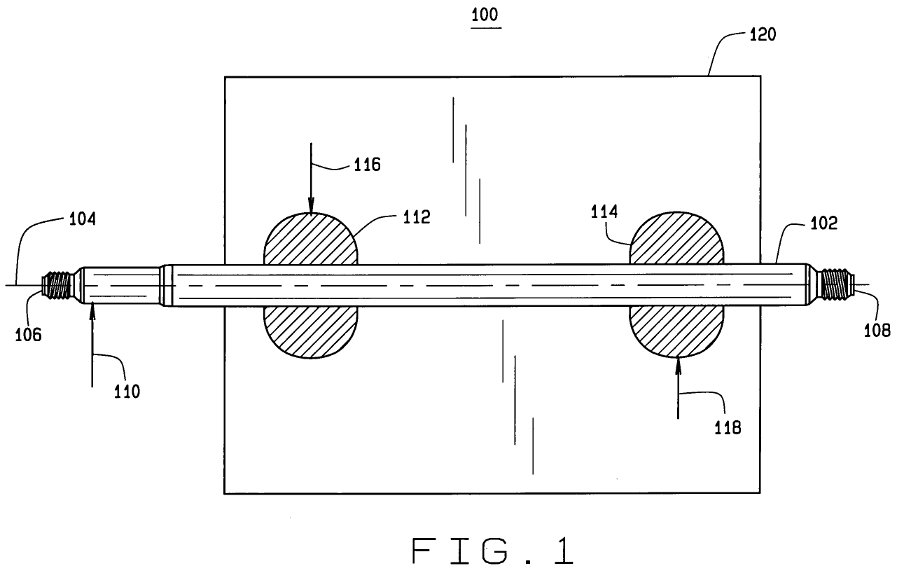

Referring now to the drawings, FIG. 1 illustrates a motor assembly 100. Motor assembly 100 includes a rotatably mounted shaft 102 having a center axis 104. Shaft 102 is composed of steel having a carbon content greater than about 0.4 percent by weight. Shaft 102 is non-secondary hardened. In some embodiments, shaft 102 may have been work hardened during shaft formation. Shaft 102 has a first end 106 and a second end 108. First end 106 and/or second end 108 may be a drive or work end of motor assembly 100. In operation, shaft 102 receives a work force that includes a portion applied along a radial to shaft 102 and/or center axis 104. While illustrated as being applied near the end of shaft 102, radial work force 110 may be applied to any portion of shaft 102. Typically, the work end drives a load or working device such as a pulley or belt (not shown) to provide mechanical power for a particular motor application.

Motor assembly 100 also includes one or more bearings such as illustrated as first bearing 112 and second bearing 114. First bearing 112 and/or second bearing 114 is coupled to shaft 102 to provide for rotation of shaft 102 about center axis 104. At least first bearing 112 is a powder metal bearing. Such a powder metal bearing has a porous structure that contains a bearing lubricant. The bearing lubricant is transmitted through the porous structure of the powder metal bearing to provide lubrication between the bearing and the shaft. A powder metal bearing may be selected from any type of powder metal bearing that includes various metals. In one preferred embodiment, the bearing is an iron graphite powder metal bearing. However, in other embodiments, a powder metal bearing may be a bronze, bronze graphite, leaded bronze, iron bronze, iron copper, or iron powder metal bearing. In another preferred embodiment, first bearing 112 is a self-aligning powder metal bearing. In another embodiment, motor assembly 100 and bearing 112 do not include a wick-fed bearing lubrication system that provides a supplemental lubrication to bearing 112. Similarly, second bearing 114 may also be a powder metal bearing. Such second bearing may be self-aligning and/or may be non-wick fed.

One or more motor components coupled to shaft 102 receive a reaction force because of radial work force 110 being applied to shaft 102. In one embodiment, first end 106 of shaft 102 receives radial work force 110 from an external load which in turn creates reaction loading or reaction forces on various motor components including one or more bearings. As illustrated in FIG. 1, first bearing 112 may be the bearing positioned about shaft 102 nearest radial work force 110. As illustrated, a first reaction force 116 is applied to first bearing 112 due to radial work force 110. Other reaction forces may also be applied by radial force 110. For example, radial work force 110 may also cause a second reaction force 118 on second bearing 114. If other bearings are present in motor assembly 100, other reaction forces may also be applied to them.

In one embodiment, the non-wick fed powder metal bearing used in motor assembly 100 is configured to drive a large radial load. In operation, motor assembly 100 may be utilized in a motor implementation that results in such a large radial load being applied to the non-wick fed powder metal bearing. For example, such an embodiment may have a load carrying capacity of greater than or equal to about 25,000 pound-feet per square inch-minute.

As discussed, shaft 102 is composed of steel having a carbon content greater than or equal to about 0.4 percent by weight. In some embodiments, shaft 102 is composed of steel having a carbon content from between about 0.4 percent to about 0.48 percent. In other embodiments, shaft 102 is composed of steel having a carbon content in the range from about 0.42 percent to about 0.5 percent. In yet other embodiments, shaft 102 is composed of steel having a carbon content of about 0.37 percent to about 0.45 percent. For example, American Iron and Steel Institute (AISI) rated steels having a steel content greater than or equal to about 0.4 percent may include AISI 1045 steel, AISI 1137 steel, AISI 1144 steel, and AISI 1141 steel. Shaft 102 may also be formed from steel having a medium carbon content (greater than about 0.09 percent and less than about 0.5 percent) or a high carbon content (greater than 0.5 percent).

As noted, shaft 102 is a non-secondary hardened steel shaft having a carbon content greater than or equal to 0.4 percent. Shaft 102 may be formed by machining, grinding, pressing, rolling, and/or other manufacturing operations wherein one or more shaft features are formed. Such shaft features may be defined for a particular motor application including coupling of a pulley or other device. For example, shaft 102 may be ground to provide compliance with a roundness and/or surface texture specification.

Such shaft forming may work harden shaft 102 either throughout entire shaft 102 or a portion thereof. While shaft 102 may be work hardened, in the embodiment of FIG. 1, shaft 102 is not secondary hardened. As such, motor assembly 100 is assembled without secondary hardening shaft 102 either as a whole assembly or on localized portions. Motor assembly 100 is further assembled as required for the particular motor application.

Motor assembly 100 may also include a motor housing 120 in which one or more of the components may be housed. It should be understood that motor assembly 100 may also include other motor components not illustrated in FIG. 1, such as a stator assembly and a rotor assembly.

Motor assembly 100 having one or more non-wick fed powder metal bearings may provide for the reducing the cost of the motor and the elimination of one or more assembly steps. In other embodiments, a motor assembly 100 with a non-secondary hardened shaft with a carbon content greater than or equal to about 0.4 percent provides for the advantageous elimination of one or more motor manufacturing operations associated with the complex, time consuming, and costly secondary hardening of the entire shaft by thermo-chemical secondary hardening. By eliminating one or both of these motor and manufacturing requirements, assembly of motor assembly 100 with powder metal bearings may be further automated and the cost of manufacturing reduced.

In operation, a motor may be assembled having a non-hardened steel shaft with a carbon content greater than or equal to about 0.4 percent by weight and a powder metal bearing coupled about the non-secondary hardened shaft. In such a case, the motor may be used where a radial load to the bearing is greater than about 25,000 pound-feet per square-inch minute. In such an embodiment, the powder metal bearing may be a wick-fed powder metal bearing or a non-wick fed powder metal bearing. In other embodiments, the powder metal bearing may be a self-aligning bearing. The powder metal bearing may be any type of powder metal bearing as described above. Additionally, the steel shaft has a carbon content greater than or equal to about 0.4 percent by weight may be any known steel having such carbon content including those previously discussed.

In such embodiments, the motor with a non-secondary hardened shaft may be used in an application where a powder metal bearing has a load carrying capacity of greater than about 25,000 pound-feet per square inch-minute. By eliminating the process of secondary hardening of the shaft, such a motor may be assembled using improved automated manufacturing operations thereby reducing the manufactured cost of the motor.

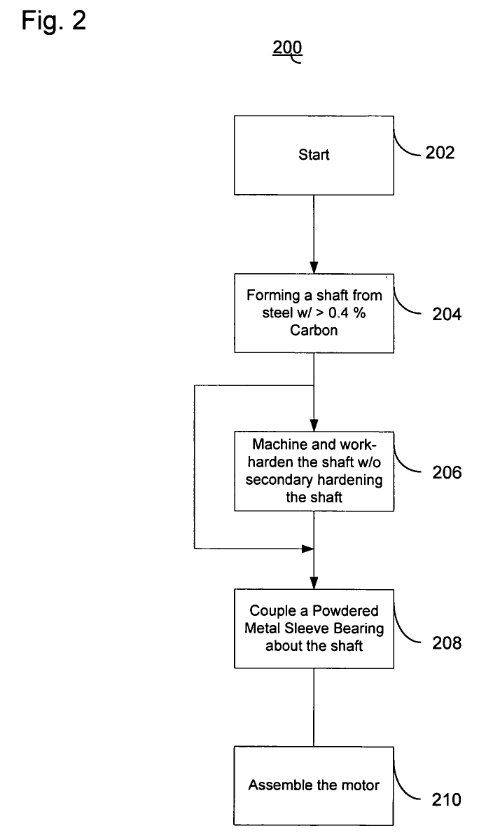

A method of manufacturing a motor according to one embodiment is illustrated in FIG. 2 and will now be described. Illustrated method 200 starts an assembly process in block 202. A shaft is formed from steel having a carbon content greater than or equal to about 0.4 percent. During formation, the shaft may be ground, machined, or otherwise prepared for compliance with one or more specifications to include one or more features for a particular motor application. This may include forming or modification such as surface smoothness, roundness, diameter, rolling, and end preparation such as diameter changes and threading. Such forming operations may work hardened all or a portion of the shaft as provided by optional block 206. However, the shaft is not otherwise secondary hardened.

A powder metal bearing is coupled about the non-secondary hardened shaft in block 208. Such coupling may provide for coupling of the bearing about the shaft such that the shaft rotates within an inner portion of the bearing. The bearing couples to the shaft at a portion of the non-secondary hardened shaft. For example, the shaft may include a non-secondary hardened bearing journal. The method also provides for assembly of the motor assembly in block 210 with the non-secondary hardened shaft having a carbon content greater than or equal to about 0.4 percent by weight and one or more powder metal bearings. In a preferred embodiment, assembly will provide for two powder metal bearings. No other bearings would be included. As such, in operation one or each of the two powder metal bearings would support a load-carrying capacity of greater than about 25,000 pound-feet per square-inch minute. Such an assembly method does not include assembling a wick or wick-feed mechanism in the motor assembly for providing supplemental bearing lubrication to the powder metal bearing.

In some operations, assembly of a motor according to manufacturing method 200 provides for improved automated manufacturing of a motor with one or more powder metal bearings. One or more improved automated manufacturing operations may be due to the elimination of secondary hardening the shaft during the manufacturing of a motor with the powder metal bearing. Additionally, an improvement and cost reduction may also be associated with the elimination of a wick-feed component of the motor assembly or bearing.

In some embodiments, a shaft having a carbon content greater than or equal to about 0.4 percent by weight according to the invention has a hardness greater than the hardness of the bearing. For example, in one embodiment, a shaft has a hardness greater than the hardness of the bearing as defined on the Rockwell B scale. In another embodiment, a shaft has a hardness greater than a hardness of a bearing by about 25 points or more on the Rockwell B hardness scale.

The principles of the invention can be applied to a wide variety of electric motors and motor applications. In one preferred embodiment, this includes appliances such as large appliances. Large appliances may include a clothing washer, a clothing dryer, and a dish or kitchenware washer. A motor according to some embodiments includes a single-speed induction motor, a three-phase or single-phase squirrel cage induction motor, a shaded-pole induction motor, two pole induction motor, permanent-split capacitor induction motor, two-speed induction motor, electronic variable-speed motor, and universal AC/DC motor.

It should be understood that when introducing aspects of the invention or various embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

It is further understood that the steps or operations described herein are not to be construed as necessarily requiring their performance in the particular order discussed or illustrated. It is also to be understood that additional or alternative steps or operations may be employed.

As various changes could be made in the above exemplary constructions and methods without departing from the scope of the invention, it is intended that all matter contained in the above description or shown in the accompanying drawings shall be interpreted as illustrative and not in a limiting sense.

1. A motor comprising:
a steel shaft having a carbon content greater than or equal to about 0.4 percent by weight, said shaft being non-secondary hardened; and
a non-wick fed powder metal bearing coupled about the non-secondary hardened shaft.

2. The motor of claim 1 wherein the non-wick fed powder metal bearing is selected from the group consisting of iron graphite, bronze, bronze graphite, leaded bronze, iron bronze, iron copper, and iron powder metal bearings.

3. The motor of claim 1 wherein the non-wick fed powder metal bearing is self-aligning.

4. The motor of claim 1 wherein the steel shaft is selected from the group consisting of an AISI 1045 steel shaft, an AISI 1137 steel shaft, and an AISI 1144 steel shaft.

5. The motor of claim 1 wherein the carbon content of the shaft is from about 0.42 percent to about 0.5 percent.

6. The motor of claim 1 wherein the non-wick fed powder metal bearing has a load carrying capacity (PV) of greater than about 25,000 pound-feet per square inch-minute.

7. A method of using a motor, said motor having a non-hardened steel shaft with a carbon content greater than or equal to about 0.4 percent by weight and a powder metal bearing coupled about the non-secondary hardened shaft, the method comprising applying a radial load to the bearing greater than about 25,000 pound-feet per square-inch minute.

8. The method of claim 7 wherein the powder metal bearing is a non-wick fed powder metal bearing.

9. The method of claim 7 wherein the powder metal bearing is selected from the group consisting of iron graphite, bronze, bronze graphite, leaded bronze, iron bronze, iron copper, and iron powder metal bearings.

10. The method of claim 7 wherein the powder metal bearing is self-aligning.

11. The method of claim 7 wherein the steel shaft is selected from the group consisting of an AISI 1045 steel shaft, an AISI 1137 steel shaft, and an AISI 1144 steel shaft.

12. The method of claim 7 wherein the carbon content is from about 0.42 percent to about 0.5 percent.

13. A method of manufacturing a motor, the method comprising:
forming a shaft from non-secondary hardened steel having a carbon content greater than or equal to about 0.4 percent by weight;
coupling a non-wick fed powder metal bearing about the non-secondary hardened shaft.

14. The method of claim 13 wherein the non-wick fed powder metal bearing is a self-aligning powder metal bearing.

15. The method of claim 13 wherein the non-secondary hardened steel shaft is selected from the group consisting of an AISI 1045 steel shaft, an AISI 1137 steel shaft, and an AISI 1144 steel shaft.

16. The method of claim 13 wherein the carbon content of the shaft is from about 0.42 percent to about 0.5 percent.

17. A shaft and bearing assembly for an electric motor comprising a non-secondary hardened shaft having a carbon content greater than or equal to about 0.4 percent and a non-wick fed powder metal bearing coupled about said shaft.

18. The shaft assembly of claim 17 wherein the non-wick fed powder metal bearing is self-aligning.

19. The shaft assembly of claim 17 wherein the shaft is selected from the group consisting of an AISI 1045 steel shaft, an AISI 1137 steel shaft, and an AISI 1144 steel shaft.

20. The shaft assembly of claim 17 wherein the carbon content of the shaft is from about 0.42 percent to about 0.5 percent.

21. The shaft assembly of claim 17 wherein the non-wick fed powder metal bearing has a load carrying capacity of greater than about 25,000 pound-feet per square inch-minute.
